(19) United States
(12) Patent Application Publication
(10) Pub. No.: US 2022/0226676 A1
(43) Pub. Date: Jul. 21, 2022

(54) POWERED AIR PURIFYING RESPIRATOR

(71) Applicant: American PAPR LLC, Brooklyn, NY (US)

(72) Inventors: Daniel COHEN, Brooklyn, NY (US); Scott CORNEZ, New York, NY (US); Jason MAZZA, Brooklyn, NY (US); Jerson MEZQUITA, Bronx, NY (US); James SCHWARTZ, Brooklyn, NY (US)

(73) Assignee: American PAPR LLC, Brooklyn, NY (US)

(21) Appl. No.: 17/577,851

(22) Filed: Jan. 18, 2022

Related U.S. Application Data
(60) Provisional application No. 63/139,170, filed on Jan. 19, 2021.

(51) Int. Cl. A62B 18/00; A62B 7/10; A62B 9/00

(52) U.S. Cl. CPC A62B 18/006; A62B 9/006; A62B 7/10

(57) ABSTRACT

A respirator system includes a hood, a breathing tube, and an air purification device. The breathing tube is coupled to the hood and has an inner surface coated in an antimicrobial coating. The air purification device is coupled to the breathing tube and is further configured to deliver filtered air to the hood via the breathing tube. The air purification device includes a housing, a back pad, a filter, a fan, a power source, and a controller. The housing includes a front housing component and a rear housing component. The back pad is configured to provide a cushion between the rear housing component and the user's body. The fan is configured to pull ambient air through the filter and deliver the filtered air to the hood. The power source is configured to supply power to the fan. The controller is configured to regulate a speed of the fan.

### CROSS-REFERENCE TO RELATED PATENT APPLICATIONS

This application claims priority to and the benefit of U.S. Provisional Patent Application No. 63/139,170, filed Jan. 19, 2021, which is incorporated herein by reference in its entirety.

### TECHNICAL FIELD

The present disclosure relates generally to air purifying respirator systems and, more specifically, to wearable, powered air purifying respirator systems.

### BACKGROUND

Powered Air Purifying Respirators (PAPRs) are an important type of respiratory personal protective equipment (PPE). For example, PAPRs are often used during a variety of medical procedures to protect healthcare professionals from dangerous airborne particles, such as viruses and bacteria. Additionally, PAPRs are used in various industrial settings to protect workers from breathing in various types of hazardous particulate.

### SUMMARY

One embodiment of the present disclosure relates to a respirator system. The respirator system comprises a hood, a breathing tube, and an air purification device. The hood is configured to be worn by a user. The breathing tube is coupled to the hood, the breathing tube having an inner surface provided with an antimicrobial coating. The air purification device is configured to be worn by the user. The air purification device is coupled to the breathing tube and is further configured to deliver filtered air to the hood via the breathing tube. The air purification device comprises a housing, a back pad, a filter, a fan, a power source, and a controller. The housing comprises a front housing component and a rear housing component. The back pad is arranged adjacent to the rear housing component and is configured to provide a cushion between the rear housing component and the user's body. The filter is arranged within the housing. The fan is arranged within the housing. The fan is configured to pull ambient air through the filter and deliver the filtered air through the breathing tube to the hood. The power source is arranged within the housing. The power source is configured to supply power to the fan. The controller is arranged within the housing. The controller is communicatively coupled to the fan and the power source. The controller is configured to regulate a speed of the fan.

Another embodiment of the present disclosure relates to an air purification device configured to be worn by a user and to deliver filtered air to the user via a breathing tube. The air purification device comprises a housing, a back pad, a filter, a fan, a power source, and a controller. The housing comprises a front housing component and a rear housing component. The back pad is arranged adjacent to the rear housing component and is configured to provide a cushion between the rear housing component and the user's body. The filter is arranged within the housing. The fan is arranged within the housing. The fan is configured to pull ambient air through the filter and deliver the filtered air through the breathing tube to the user. The power source is arranged within the housing. The power source is configured to supply power to the fan. The controller is arranged within the housing. The controller is communicatively coupled to the fan and the power source. The controller is configured to regulate a speed of the fan.

Another embodiment of the present disclosure relates to a respirator system. The respirator system comprises a hood, a breathing tube, a heart rate monitor, and an air purification device. The hood is configured to be worn by a user. The breathing tube is coupled to the hood. The heart rate monitor is configured to detect a heart rate of the user. The air purification device is configured to be worn by the user. The air purification device is coupled to the breathing tube and is further configured to deliver filtered air to the hood via the breathing tube. The air purification device comprises a housing, a back pad, a filter, a fan, a power source, and a controller. The housing comprises a front housing component and a rear housing component. The back pad is arranged adjacent to the rear housing component and is configured to provide an ergonomic cushion between the rear housing component and the user's body. The filter is arranged within the housing. The fan is arranged within the housing. The fan is configured to pull ambient air through the filter and deliver the filtered air through the breathing tube to the hood. The power source is arranged within the housing. The power source is configured to supply power to the fan. The controller is arranged within the housing. The controller is communicatively coupled to the fan, the power source, and the heart rate monitor. The controller is configured to regulate a speed of the fan based on the heart rate of the user.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is an exploded perspective view of a respiratory system, according to an exemplary embodiment.

FIG. 2 is a front perspective view of an air purification device of the respiratory system of FIG. 1, according to an exemplary embodiment.

FIG. 3 is a rear perspective view of the air purification device of FIG. 2, according to an exemplary embodiment.

FIG. 4 is a rear perspective view of a front housing component of the air purification device of FIG. 2, according to an exemplary embodiment.

FIG. 5 is a front view of a rear housing component of the air purification device of FIG. 2, according to an exemplary embodiment.

FIG. 6 is a rear perspective view of the rear housing component of FIG. 5, according to an exemplary embodiment.

FIG. 7 is a front view of a back pad of the air purification device of FIG. 2, according to an exemplary embodiment.

FIG. 8 is front view of the air purification device of FIG. 2, shown with the front housing component removed, according to an exemplary embodiment.

FIG. 9 is a front view of the air purification device of FIG. 2, shown with the front housing component and various battery components removed, according to an exemplary embodiment.

FIG. 10 is a rear view of the air purification device of FIG. 2, shown with the back pad and rear housing component removed, according to an exemplary embodiment.

FIG. 11 is a front perspective view of a battery tray of the air purification device of FIG. 2, according to an exemplary embodiment.

FIG. 12 is a front perspective view of an internal seal of the air purification device of FIG. 2, according to an exemplary embodiment.

FIG. 13 is a rear perspective view of an outlet duct of the air purification device of FIG. 2, according to an exemplary embodiment.

FIG. 14 is a cross-sectional view of the air purification device of FIG. 2, taken along line 14-14, according to an exemplary embodiment.

FIG. 15 is an exploded view of a quick-disconnect fitting having a battery retention collar, according to an exemplary embodiment.

FIG. 16 is a partial side view of the air purification device of FIG. 2, shown with the quick-disconnect fitting of FIG. 15, according to an exemplary embodiment.

FIG. 17 is a partial rear perspective view of the air purification device of FIG. 16, according to an exemplary embodiment.

FIG. 18 is a front view of another air purification device for use with the respiratory system of FIG. 1.

FIG. 19 is a front view of the air purification device of FIG. 18, shown with an external seal plate removed.

FIG. 20 is a front view of the external seal plate of the air purification device of FIG. 18.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein relate generally to a respirator system for providing a positive-pressure purified or filtered air supply to a user. The respirator system includes, among other things, a hood, a breathing tube, and an air purification device. During use, the air purification device is configured to be strapped or otherwise attached to the user's lower back and used to deliver the positive-pressure purified air supply to the user. In particular, a respirator system according to one or more embodiments set forth herein is provided to enhance safety, comfort and ease of use, as appreciated from the following discussion of various exemplary features.

Beneficially, the breathing tube has an inner surface coated with an antimicrobial coating to prevent cross-contamination between uses. Additionally, the breathing tube includes quick-disconnect fittings configured to allow for increased ease of attaching the breathing tube to the air purification device and/or the hood. Further, the breathing tube includes self-sealing openings at both ends that are configured to automatically provide a hermetic seal upon disconnecting the breathing tube from the air purification device and/or the hood. The self-sealing openings are thus configured to protect an inner cavity within the breathing tube from being exposed to the environment, thereby preventing contamination of the breathing tube. Similarly, the air purification device includes a self-sealing valve configured to automatically provide a hermetic seal when the breathing tube is detached.

In some instances, the respirator system includes a heart rate monitor, and a controller of the air purification device is beneficially configured to adjust a speed of a fan configured to deliver the positive-pressure purified air supply to the user based upon a sensed heart rate of the user. Accordingly, the user may be provided with a higher supply of purified air in the case that they are physically exerted or otherwise working in a stressful environment while using the respirator system.

Additionally, the respirator system is generally configured to be used for extended periods of time. For this reason, the air purification device includes a back pad configured to provide an ergonomic cushion between the user and the air purification device. The back pad is configured to allow for the respirator system to be used for extended periods of time while mitigating discomfort and/or strain that the user may otherwise experience if the air purification device were in direct contact with the user's lower back.

The various concepts introduced above and discussed in greater detail below may be implemented in any of numerous ways, as the described concepts are not limited to any particular manner of implementation. Examples of specific implementations and applications are provided primarily for illustrative purposes.

Various numerical values herein are provided for reference purposes only. Unless otherwise indicated, all numbers expressing quantities of properties, parameters, conditions, and so forth, used in the specification and claims are to be understood as being modified in all instances by the term “approximately.” Accordingly, unless indicated to the contrary, the numerical parameters set forth in the following specification and attached claims are approximations. Any numerical parameter should at least be construed in light of the number of reported significant digits and by applying ordinary rounding techniques. The term “approximately” when used before a numerical designation, e.g., a quantity and/or an amount including range, indicates approximations which may vary by (+) or (−) 10%, 5%, or 1%.

As will be understood by one of skill in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member.

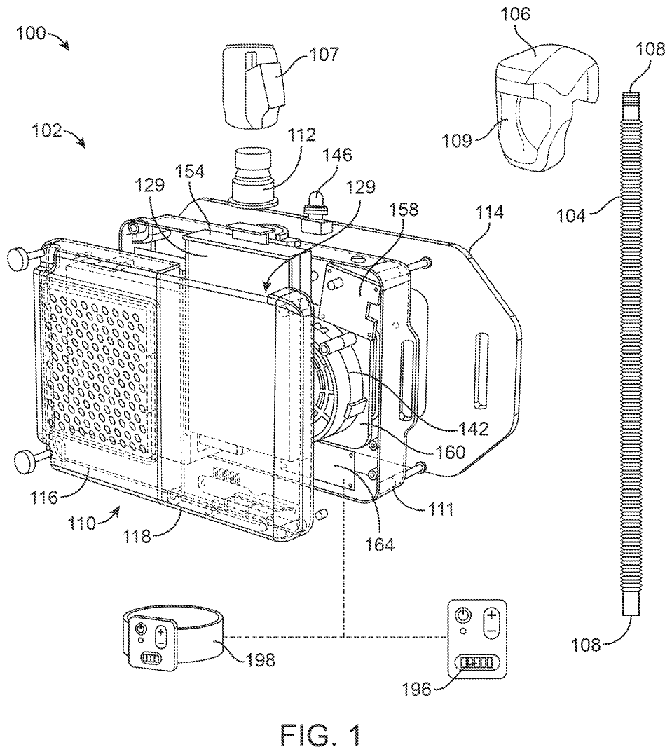

FIG. 1 is an exploded view of a respirator system 100, according to an exemplary embodiment. In some embodiments, the respirator system 100 is a powered air-purifying respirator system configured to provide a positive-pressure purified air supply to a user. For example, in some instances, the positive-pressure purified air supply provided by the respirator system 100 may be used to prevent a user (e.g., a health professional) from breathing in or otherwise being exposed to aerosolized fluids, airborne pathogens, contaminants and/or other hazardous particulates during a variety of medical procedures. In other embodiments, the respirator system 100 may be used in a variety of other settings as desired for a given application.

The respirator system 100 includes an air purification device 102 (an air purifier), a breathing tube 104, and a hood 106. As a general overview, during use, the hood 106 is configured to be worn on the user's head and the air purification device 102 is configured to be strapped to the user's lower back using body straps. The air purification device 102 is then configured to provide the positive-pressure air supply, through the breathing tube 104, into the hood 106 to the user.

In some instances, the breathing tube 104 includes one or more quick disconnect fittings 107 to allow for the user to easily attach the breathing tube 104 to the air purification device 102 and/or the hood 106. In some embodiments, an inner surface of the breathing tube 104 may be coated with an antimicrobial and/or biocidal material. For example, in some instances, the inner surface of the breathing tube 104 may be coated with a silver ion (Ag+) coating. The silver ion coating has biocidal properties, allowing for reuse of the breathing tube 104 with a lower risk of contamination. By coating the inner surface of the breathing tube 104, the breathing tube 104 may be reused without the concern of contamination between uses.

Additionally, the breathing tube 104 further includes self-sealing ends 108 including valves (e.g., disposed within the quick disconnect fittings 107) that are configured to automatically seal when the breathing tube 104 is disconnected from either the air purification device 102 and/or the hood 106. By including self-sealing ends 108 having the valves configured to automatically seal when disconnected from the air purification device 102 and/or the hood 106, the inner cavity of the breathing tube 104 is effectively protected from the environment when the breathing tube 104 is detached from the air purification device 102 and/or the hood 106, which thus prevents contaminants from being collected within the inner cavity of the breathing tube 104.

The hood 106 is configured to be worn by the user during use of the respirator system 100. As illustrated in FIG. 1, the hood includes a hood shield 109 made of a transparent material. Accordingly, the hood shield 109 is configured to allow the user to see out of the hood 106 during use. In some instances, the entire hood 106 may be made of a transparent material to enhance interpersonal interaction between the user and others during use of the respirator system 100. In some embodiments, the hood 106 may further include a port that enables one or more magnifying loupes to be utilized by the user during use without interfering with the hood shield 109. This may be particularly beneficial for certain procedures, e.g., dental procedures.

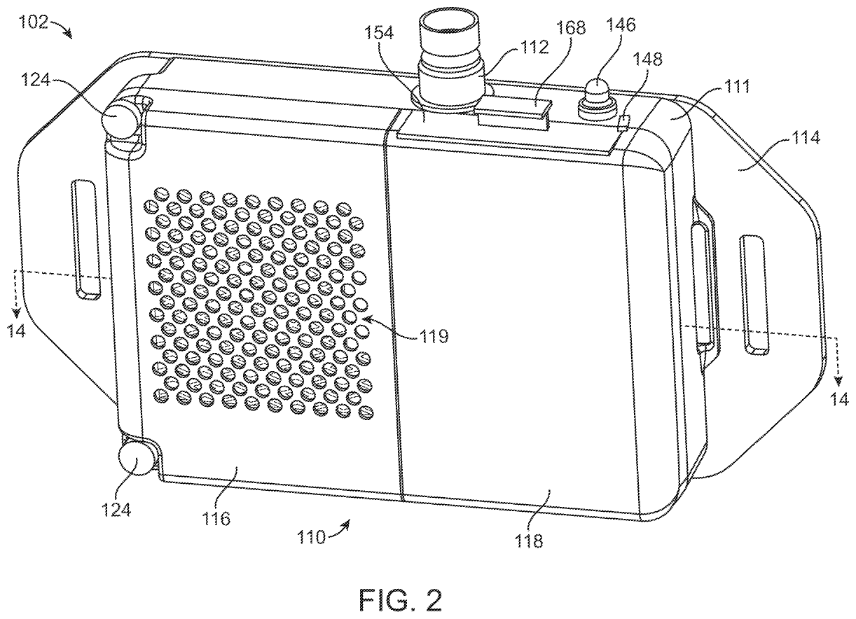

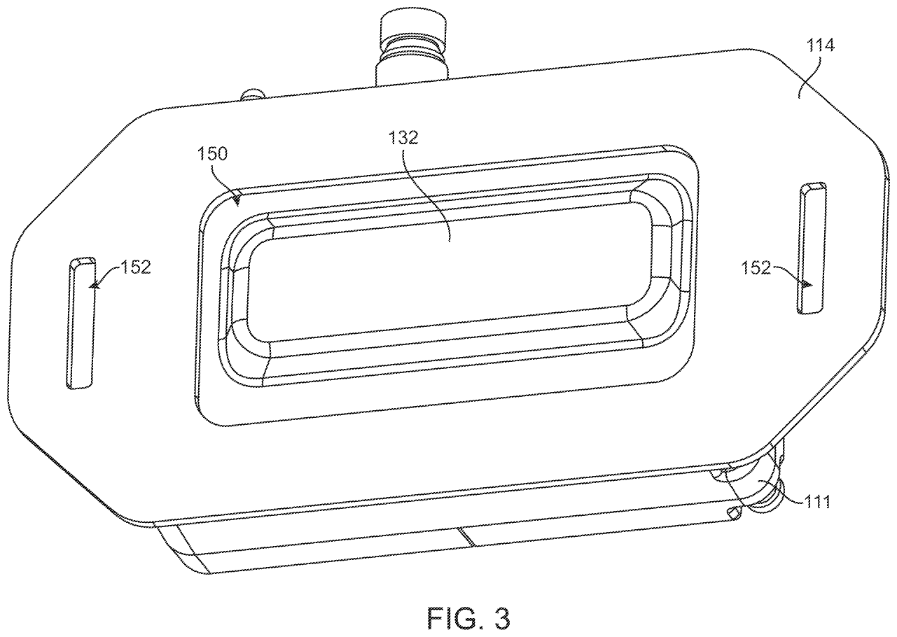

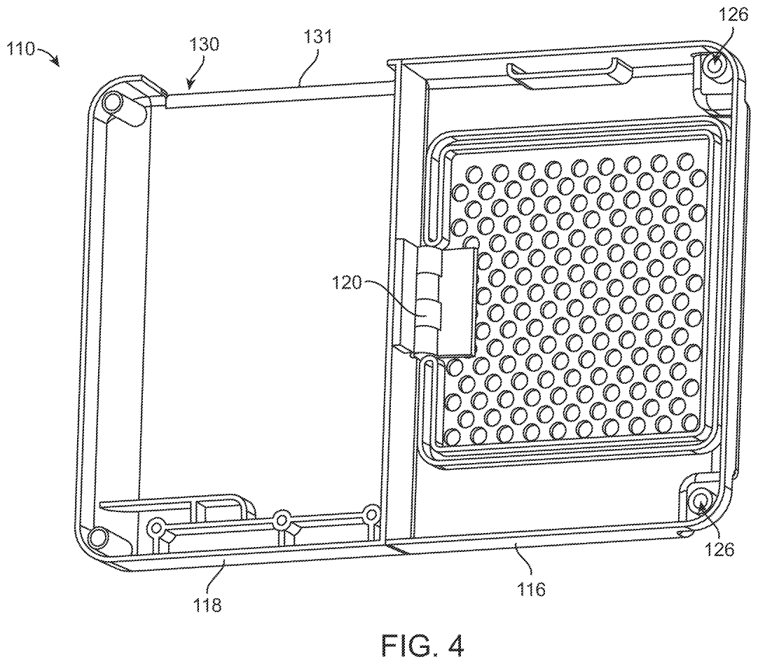

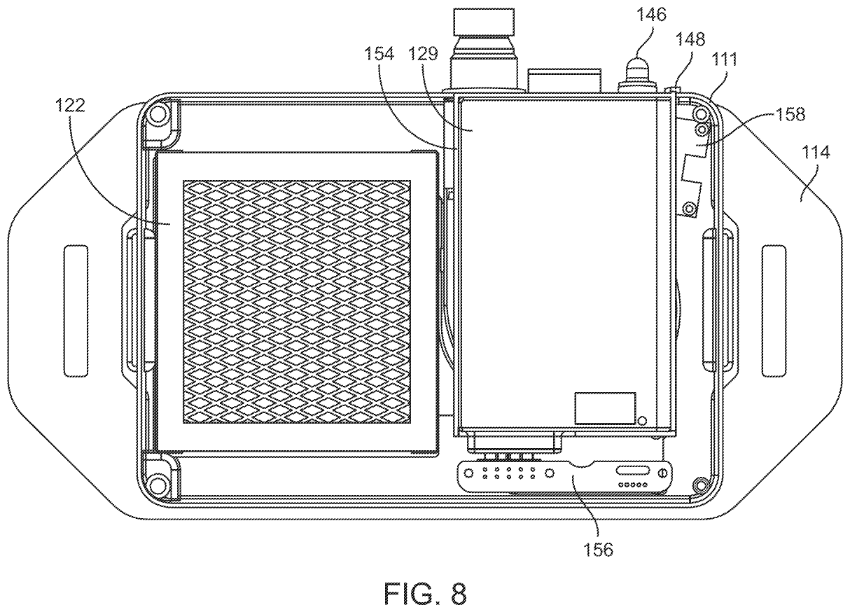

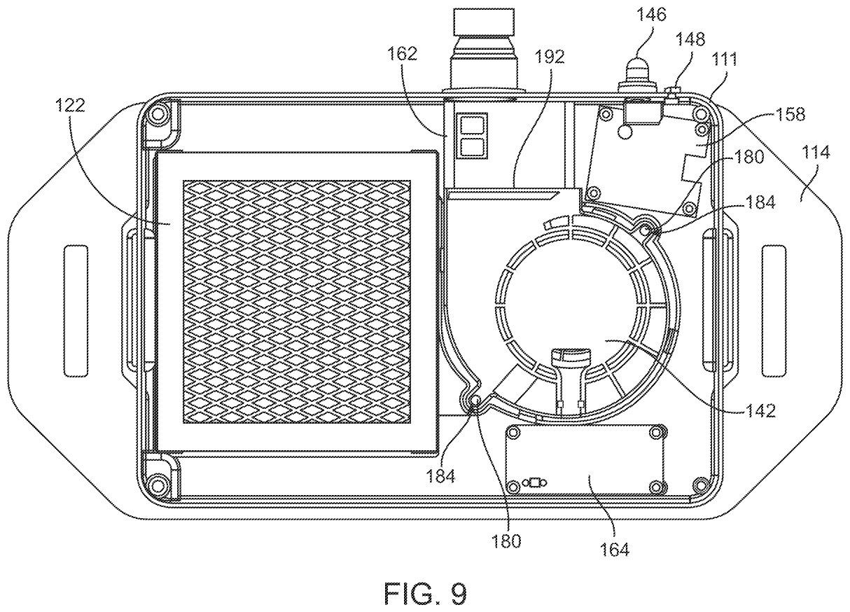

Referring now to FIGS. 2 and 3, the air purification device 102 includes a housing formed by a front housing component 110 and a rear housing component 111, a quick-disconnect fitting 112, and a back pad 114. In some instances, the housing, including the front housing component 110 and the rear housing component 111, may be formed of a plastic material. For example, each of the front housing component 110 and the rear housing component 111 may be formed using a plastic injection-molding process. The front housing component 110 comprises a filter cover 116 and a battery compartment 118. The filter cover 116 includes a plurality of intake apertures 119 configured to allow for air to be pulled through the filter cover 116 during use. As best illustrated in FIG. 4, the filter cover 116 is coupled to the battery compartment 118 by a filter cover hinge 120. As such, the filter cover 116 is configured to swing on the filter cover hinge 120 between an open position (e.g., out of the page with respect to FIG. 2) and a closed position (shown in FIG. 2) to allow for a filter 122 (shown in FIGS. 8 and 9) of the air purification device 102 to be replaced.

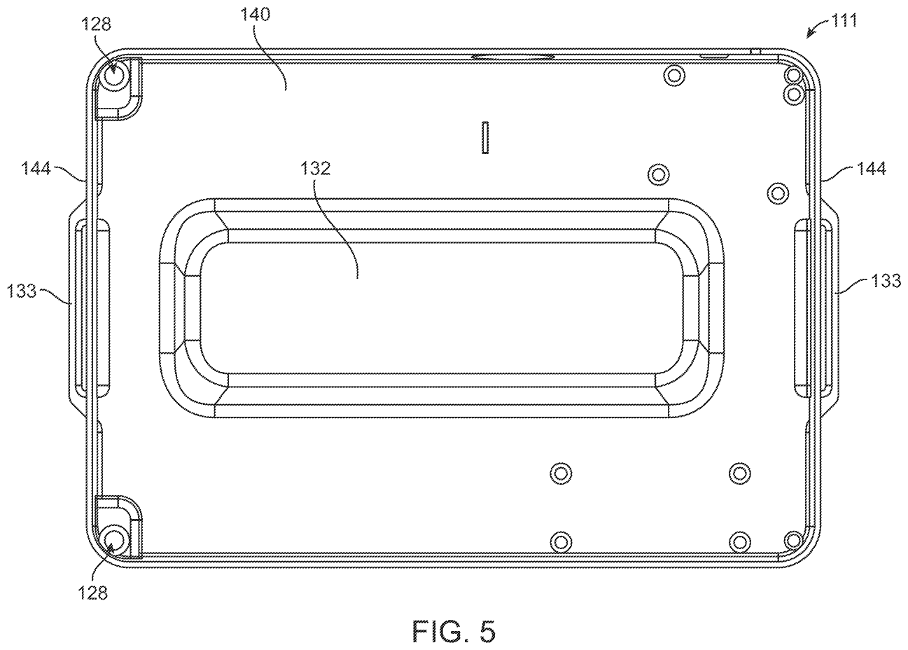

As illustrated in FIG. 2, a pair of removable screws 124 are configured to retain the filter cover 116 in the closed position during use. Specifically, the pair of removable screws 124 are configured to extend through corresponding apertures 126 (shown in FIG. 4) in the filter cover 116 and be threadably received by corresponding threaded apertures 128 (shown in FIG. 5) in the rear housing component 111 to selectively lock the filter cover 116 in the closed position. The pair of removable screws 124 are further configured to be optionally manually tightened or loosened to lock or open the filter cover 116, without the use of external tools.

As shown in FIG. 4, the battery compartment 118 is configured to house a battery 129 (shown in FIG. 8) of the air purification device 102. The battery compartment 118 includes a battery slot 130 at a top end 131 of the battery compartment 118. The battery slot 130 is configured and sized to removably receive the battery 129, which is inserted into the battery compartment 118 to power the components of the air purification device 102.

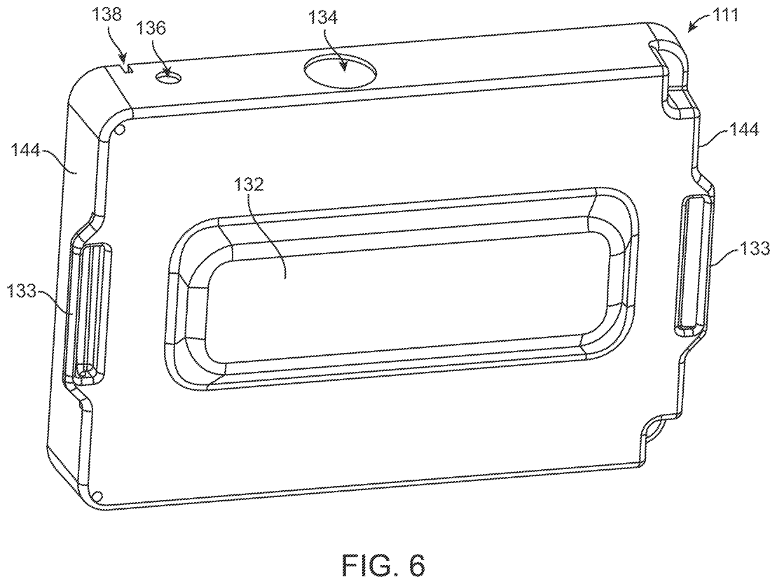

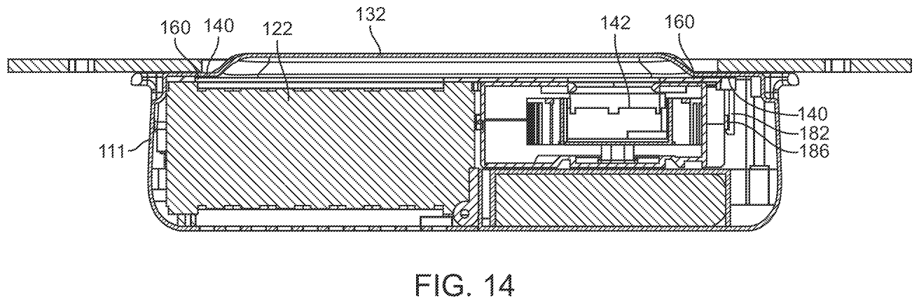

Referring now to FIGS. 5 and 6, the rear housing component 111 includes the threaded apertures 128 (shown in FIG. 5), an air channel 132, body strap attachment features 133, an outlet port 134 (shown in FIG. 6), a power button aperture 136 (shown in FIG. 6), and a battery retention mechanism slot 138 (shown in FIG. 6). The air channel 132 is recessed into a front surface 140 (shown in FIG. 5) of the rear housing component 111. The air channel 132 is configured to provide a channel for purified air to pass through from the filter 122 to a fan 142 (shown in FIG. 9) to be provided through the breathing tube 104 and into the hood 106 during use (as best illustrated in FIG. 14). The body strap attachment features 133 are disposed on lateral sides 144 of the rear housing component 111. The body strap attachment features 133 are configured to receive and be attached to body straps used to secure the air purification device 102 to the user during use. The outlet port 134 is configured to receive the quick-disconnect fitting 112 to allow for purified air to flow out of the air purification device 102.

In some instances, the quick-disconnect fitting 112 and/or the outlet port 134 may additionally include a self-sealing valve mechanism configured to hermetically seal the air purification device 102 when the breathing tube 104 is disconnected. The self-sealing valve mechanism may thus be configured to prevent contamination and enable aerosol-based cleaning methods. The power button aperture 136 is configured to receive a power button 146 (shown in FIGS. 8 and 9) used to turn the air purification device 102 on or off. The battery retention mechanism slot 138 is configured to receive a battery retention mechanism 148 (shown in FIGS. 8 and 9). The battery retention mechanism 148 may be configured to swivel within battery retention mechanism slot 138 to selectively retain the battery 129 within the battery compartment 118.

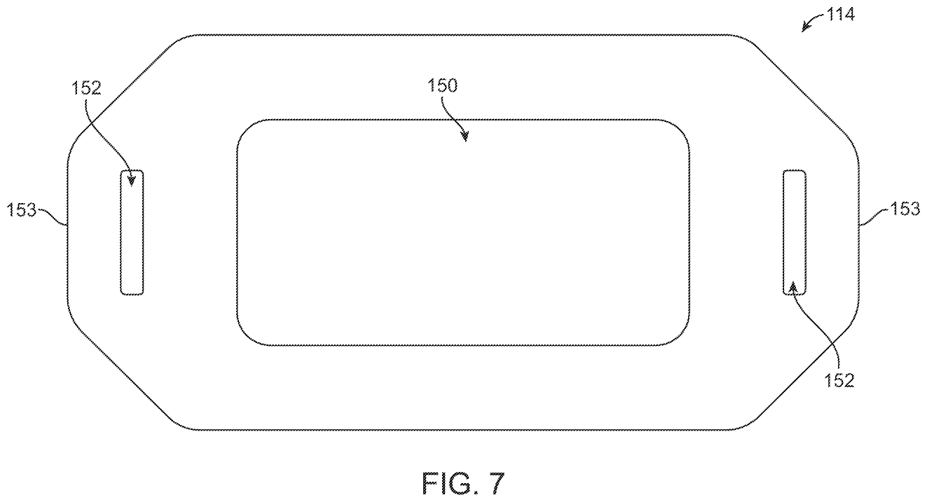

Referring now to FIG. 7, the back pad 114 includes a central opening 150 and a pair of body strap slots 152. When assembled, the back pad 114 is arranged adjacent to the rear housing component 111, and the air channel 132 of the rear housing component 111 extends into and slightly through the central opening 150 of the back pad 114 (as best illustrated in FIG. 3). The body strap slots 152 are arranged on lateral sides 153 of the back pad 114. In some embodiments, the back pad 114 may be formed of a soft (e.g., ergonomic) material. For example, the back pad 114 may be formed of a foam material, a gel material, or any other suitably soft material, or combinations thereof. In some embodiments, the back pad 114 may comprise memory foam that retains shape characteristics corresponding to a portion of the body of the individual user. The back pad 114 provides lumbar support for the user.

During use, the pair of body strap slots 152 are configured to receive the body straps, which are then attached to the body strap attachment features 133 of the rear housing component 111. As such, when the user uses the body straps to secure the air purification device 102 to the user's body, the back pad 114 gets pulled into contact with the user's lower back, thereby providing an ergonomic cushion between the user and the rear housing component 111. Additionally, the body straps may slightly bend the back pad 114 around the user's body, thereby also providing an ergonomic cushion between the user and portions of the body straps themselves.

Referring now to FIGS. 8-10 generally, various internal components stored within the housing (i.e., arranged between the front housing component 110 and the rear housing component 111) of the air purification device 102 are shown. Specifically, the air purification device 102 includes the filter 122, the battery 129, the fan 142, a battery tray 154, a battery docking circuit 156, a battery charging circuit 158, an internal seal 160, an outlet duct 162, and a controller 164. It should be appreciated that the internal components may be arranged differently than the arrangement shown in FIGS. 8-10 without departing from the scope of the present disclosure. Further, in some embodiments, the air purification device 102 may include different or additional components. In some embodiments, filter 122 may include a plurality of filters.

In some embodiments, the filter 122 may be an air purifying filter configured to filter various particles out of air pulled through the filter 122 by the fan 142. For example, the filter 122 may be configured to filter particles sized between about 0.1 to about 0.3 microns, as desired for a given application. In some embodiments, filter 122 may filter 95% or more of particles sized larger than about 0.3 microns. In some embodiments, filter 122 may filter 99% or more of particles larger than about 0.8 microns. In some embodiments, the filter 122 may be configured to meet U.S. National Institute for Occupational Safety and Health (NIOSH) standards for air purification by filtering 99.97% or more of particles 0.3 microns or larger. In some instances, the filter 122 may be carbon-based to additionally allow for chemical threat protection. As discussed above, the filter 122 is configured to be replaced, as appropriate, during operation. In some instances, the filter 122 may be held in place by an injection-molded plastic frame within the housing.

As illustrated in FIGS. 1, 2, and 8, during use, the battery 129 is inserted into the battery tray 154, which is then slid through the battery slot 130 into the battery compartment 118. When fully inserted, the battery 129 interfaces with the battery docking circuit 156 (as best illustrated in FIG. 8) to power the various electrical components of the air purification device 102. For example, the battery 129 is configured to provide power to the fan 142 to pull air through the filter 122 and provide the filtered air to the user.

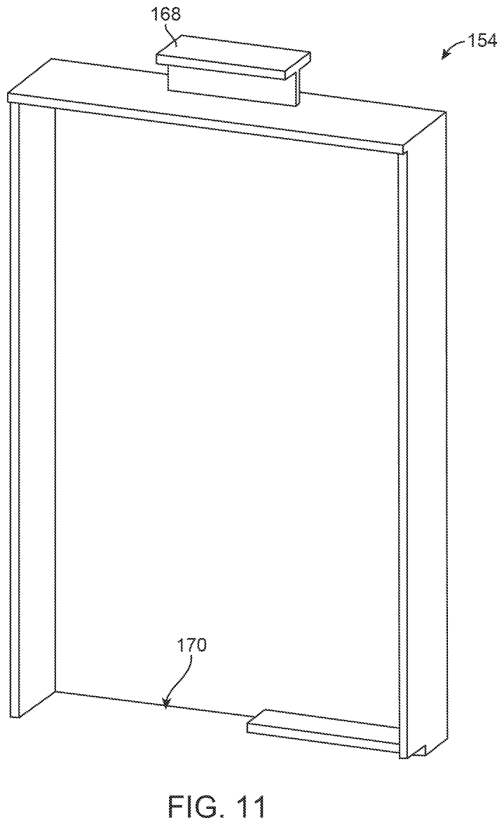

Referring now to FIG. 11, the battery tray 154 includes a battery receiving area 166, a handle 168, and a battery interface slot 170. The battery receiving area 166 is configured to removably receive the battery 129. The handle 168 is configured to provide an effective gripping component to allow for the user to easily insert and remove the battery 129 and battery tray 154 into and from the battery compartment 118 to replace the battery 129. The battery interface slot 170 is configured to provide an interface opening to allow for the battery 129 to interface (e.g., via a battery pin connector) with the battery docking circuit 156.

Referring specifically to FIG. 8, the battery docking circuit 156 is configured to interface with the battery 129 (e.g., via the battery pin connector) to effectively transmit power from the battery 129 to various components (e.g., the fan 142, the battery charging circuit 158, the controller 164) of the air purification device 102. The battery charging circuit 158 is configured to allow for dual mode charging to enable continuous operation of the air purification device 102. For example, the battery charging circuit 158 may include a capacitive element configured to independently power the electrical components of the air purification device 102 for a short period of time, thereby allowing for the user to switch out a depleted battery 129 with a charged battery 129 without having to power down or otherwise cease operation of the air purification device 102. Accordingly, in some instances, the air purification device 102 may include a pair of batteries to allow for one battery to be charged while the other battery is in use.

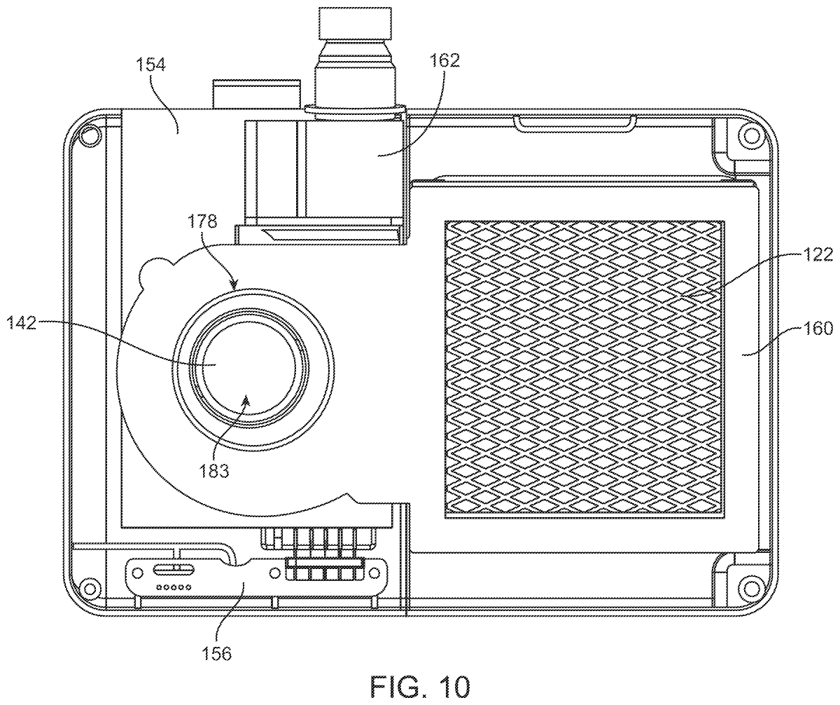

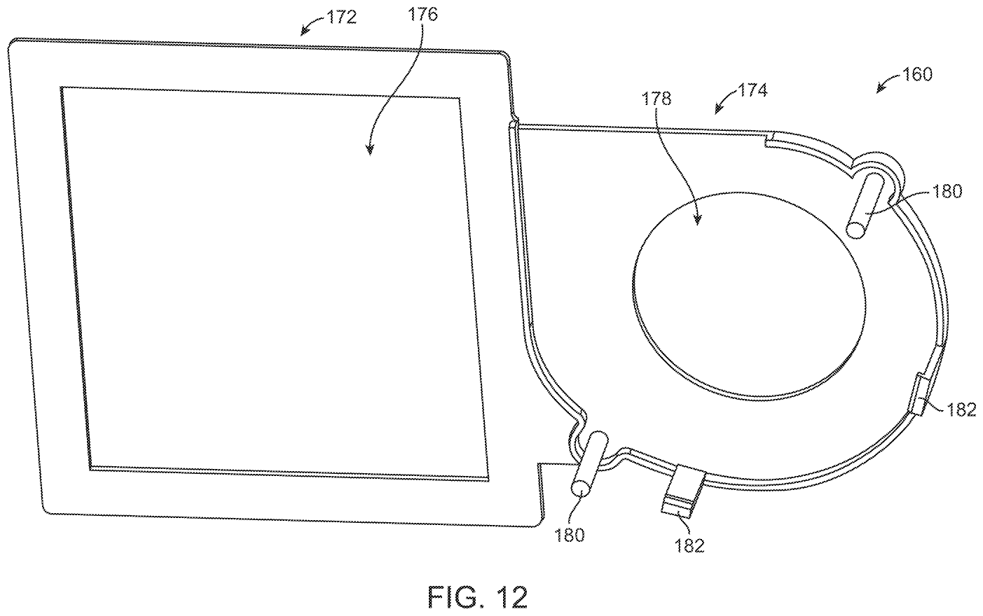

The internal seal 160 is configured to provide an effective seal between the front surface 140 of the rear housing component 111 and each of the filter 122 and the fan 142 (as best illustrated in FIG. 14), such that air pulled through the filter 122 by the fan 142 may only flow within the air channel 132 of the rear housing component 111. Referring now to FIG. 12, the internal seal 160 includes a filter portion 172 and a fan portion 174. When assembled, the filter portion 172 of the internal seal 160 is configured to contact a periphery of the filter 122 and provide an effective seal between the periphery of the filter 122 and the front surface 140 of the rear housing component 111. The filter portion 172 includes a filter opening 176 configured to allow filtered air to flow from the filter 122 into the air channel 132 formed by the rear housing component 111. Similarly, when assembled, the fan portion 174 is configured to contact a periphery of the fan 142 and provide an effective seal between the periphery of the fan 142 and the front surface 140 of the rear housing component 111. The fan portion 174 includes a fan opening 178, fan alignment pins 180, and snap-fit retention prongs 182. The fan opening 178 is configured to allow filtered air to flow from the air channel 132 formed by the rear housing component 111 into a central opening 183 (shown in FIG. 10) of the fan 142 to be provided to the user.

When assembled, the fan alignment pins 180 and the snap-fit retention prongs 182 are collectively configured to properly align and retain the internal seal 160 on the fan 142. For example, the fan alignment pins 180 are configured to be received within corresponding fan alignment apertures 184 (as shown in FIG. 9) of the fan 142, and the snap-fit retention prongs 182 are configured to engage corresponding snap-fit engagement features 186 (shown in FIG. 14) of the fan 142 by snapping onto the snap-fit engagement features 186. Accordingly, with the fan alignment pins 180 inserted into the fan alignment apertures 184 and the snap-fit retention prongs 182 engaged with the snap-fit engagement features 186, the internal seal 160 is effectively held in place, in the correct alignment, against the fan 142.

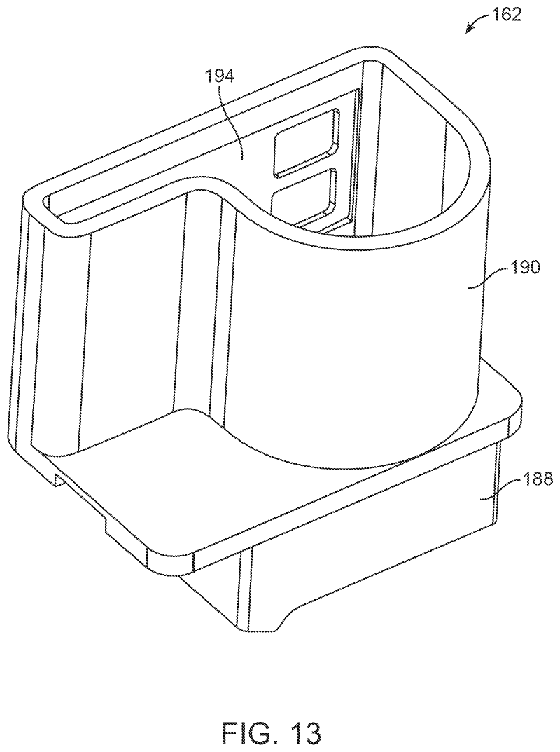

Referring now to FIG. 13, the outlet duct 162 includes a fan interface portion 188 and an outlet portion 190. The fan interface portion 188 is configured to interface with an outlet 192 (shown in FIG. 9) of the fan 142. Specifically, the fan interface portion 188 is configured to be inserted into the outlet 192 of the fan 142 to direct filtered air from the fan into the outlet duct 162. The outlet portion 190 is then configured to direct the filtered air, through the outlet port 134 and the quick-disconnect fitting 112, out of the air purification device 102 into the breathing tube 104. The outlet portion 190 further includes a flow rate sensor 194 configured to sense a flow rate of the purified air flowing through the outlet duct 162 (i.e., the flow rate of the purified air being delivered to the user).

Referring again to FIG. 1, the controller 164 is in communication with the various electrical components of the air purification device 102, including, for example, the battery 129, the fan 142, the power button 146, the battery charging circuit 158, the battery docking circuit 156, and the flow rate sensor 194. The controller 164 is communicatively coupled to each of the various electrical components via a wired or a wireless (e.g., Bluetooth, Wi-Fi) connection to allow for various electrical signals and other information to be transmitted between the controller 164 and the various electrical components. It should be appreciated that, in some instances, the air purification device 102 may include additional electrical components in communication with the controller 164. For example, the controller 164 may additionally be in communication with various internal sensors for monitoring the functionality of and conditions within the air purification device 102. In some instances, these internal sensors may include any of temperature sensors, humidity sensors, pressure sensors, air quality sensors, and/or any other suitable sensors desired for a given application.

In some embodiments, the controller 164 includes a processor and a memory. The processor may be a general-purpose processor, an application specific integrated circuit (ASIC), one or more field programmable gate arrays (FPGAs), a digital signal processor (DSP), a group of processing components, or other suitable electronic processing components. The memory may include one or more memory devices (e.g., RAM, NVRAM, ROM, Flash Memory, hard disk storage) and may store data, instructions, and/or computer code for facilitating the various processes described herein. Moreover, the memory may be or include tangible, non-transient volatile memory or non-volatile memory.

During use, the controller 164 is configured to control various aspects of the operation of the air purification device 102. For example, the controller 164 is configured to receive a signal from the power button 146 to turn the air purification device 102 on or off. Upon the air purification device 102 being turned on, the controller 164 is further configured to activate the fan 142 to pull ambient air through the filter 122 and the air channel 132, and to push the filtered air through the outlet duct 162 and out of the air purification device 102. In some embodiments, the controller 164 may control aspects of operation of the air purification device 102 using pulse-width modulation (PWM) techniques.

In some instances, the controller 164 may further utilize a sensed flow rate received from the flow rate sensor 194 to regulate the speed of the fan 142. For example, in some instances, the controller 164 may regulate the speed of the fan 142 to ensure a flow rate of approximately 6.5 cubic feet per minute (CFPM). It should be appreciated that, in other instances, the controller 164 may regulate the speed of the fan 142 to achieve various other flow rates, as desired for a given application. For example, in some instances, the controller 164 may regulate speed of the fan 142 to achieve a flow rate of between about 6 CFPM and about 9 CFPM. In some embodiments, the controller 164 may regulate the fan speed to have a flow rate of between about 6 CFPM to about 8 CFPM.

The controller 164 may be additionally configured to provide various warnings to the user during operation. For example, the controller 164 may be configured to warn the user (e.g., via a visual and/or audible alert) that the battery 129 has a low charge level and needs to be replaced. Further, the controller 164 may be configured to warn the user upon detection of a low or decreased flow rate sensed by the flow rate sensor 194, which may, for example, indicate that the filter 122 needs to be replaced, that there is a leak within the air purification device 102, or that there is a blockage within the air purification device 102. In some instances, the flow rate sensor 194 may additionally or alternatively include an audible and/or visible alarm (e.g., a buzzer and/or a flashing light) configured to alert the user that the air purification device 102 is malfunctioning.

In some instances, the controller 164 is in communication with an external remote device 196 (shown in FIG. 1). The controller 164 may wirelessly communicate with the external remote device 196 via Bluetooth, Wi-Fi, or any other suitable wireless communication method. The external remote device 196 is configured to allow the user to control and manipulate various operational aspects of the air purification device 102. For example, in some instances, the user may be able to turn the air purification device 102 on or off using the wireless external remote device 196. Additionally, in some instances, the user may be able to selectively increase or decrease the flow rate of purified air delivered by the air purification device 102 using the wireless external remote device 196. Accordingly, the external remote device 196 may be configured for manual input (e.g., utilizing a keypad-type button array). In some instances, the external remote device 196 may be additionally configured to receive vocal commands from the user. Accordingly, the external remote device 196 allows the user to control the operation of the air purification device 102 without having to take the air purification device 102 off of the user's body during use. In some instances, the external remote device 196 may further include a battery indicator configured to visually show the user how much remaining battery life the battery 129 has left.

In some instances, the respirator system 100 further includes a heart rate monitor 198 configured to be worn by the user during use. In some other instances, the user may alternatively use a wirelessly-enabled (e.g., Bluetooth-enabled, Wi-Fi enabled) heart rate monitor of their own with the respirator system 100. In either case, the controller 164 may wirelessly communicate with the heart rate monitor to regulate the speed of the fan 142. For example, the controller 164 may vary the speed of the fan 142 to provide a higher or lower flow rate based on the sensed heart rate of the user. Specifically, if the sensed heart rate of the user increases during use to be above a threshold, the controller 164 may infer that the user is in a state of stress, and may automatically increase the speed of the fan 142 to provide a higher flow rate of the purified air being supplied to the user. The controller 164 may decrease the speed of the fan to provide a lower flow rate of air in response to a determination that the heart rate is below a second threshold. This may be particularly useful in situations where users physically exert themselves, experience physiological stress, or are in an environment where they may need a higher supply of purified air than otherwise needed under normal circumstances. In some instances, the heart rate monitor 198 may include some or all of the same functionality as the external remote device 196 discussed above. As such, in some instances, the user may use the heart rate monitor 198 to power the air purification device on and/or off, as well as to selectively increase and/or decrease the flow rate of purified air delivered by the air purification device 102. The heart rate monitor 198 may similarly further include a battery indicator configured to visually show the user how much remaining battery life the battery 129 has left.

In some instances, the housing further includes one or more internal cleaning baffles configured to be selectively slid or rotated to seal off various portions of the housing. For example, in some instances, various components or surfaces within the air purification device 102 may be damaged if exposed to ultra-high throughput aerosol-based cleaning methods. In these instances, the controller 164 may be configured to selectively actuate various actuation controls to selectively seal off portions of the housing using the one or more internal cleaning baffles to allow for the aerosol-based cleaning methods to be used on the remaining portions of the air purification device 102. For example, the user may be able to press a cleaning activation button (e.g., disposed on the air purification device 102 or on the external remote device 196) or provide a vocal command (e.g., to the external remote device 196) to selectively actuate the internal cleaning baffles to allow for aerosol-based cleaning methods to be used to clean the air purification device 102 after use. Upon activation, the movement of the baffles effectuates self-sealing of portions of the air purification device 102.

The controller 164 may further be configured to continuously monitor and store information pertaining to the functionality of the air purification device 102 during operation. For example, the controller 164 may be configured to continuously monitor and store information concerning various system events, including flow rate changes, fan speed changes, heart rate changes, battery charge level changes, and/or changes in any other sensed measurements (e.g., internal temperature, internal pressure, internal humidity, internal air quality).

In some instances, the controller 164 may be configured to wirelessly upload the monitored information to a remote computing system to allow for remote monitoring and/or analysis of the respirator system 100 during use. Further, the controller 164 may be configured to log such information as historical event data. The controller 164 may be programmed to compute metrics of interest, e.g., statistical data such as the standard deviation of a data set including event data relating to one or more of the flow rate, fan speed, heart rate, temperature, etc., or the average time between when a heart rate above a first threshold is detected to when the heart rate decreases below a second threshold following an increase in fan speed, for example. A history of logged events may be uploaded wirelessly (e.g., via Bluetooth or over Wi-Fi) to a receiver (e.g., to a mobile device, a computing device, or a network such as a cloud computing network). The history may be cleared by the user or at periodic intervals, for example.

The arrangements of the various components described with reference to the respirator system 100 of FIG. 1 and the air purification device 102 of FIG. 2 are shown for illustrative purposes only. Many alternatives and combinations are possible without departing from the inventive concepts disclosed herein. For example, in some instances, the filter 122, the battery 129, the fan 142, the internal seal 160, and/or any of the electronic components of the air purification device 102 may be arranged differently within the housing of the air purification device 102.

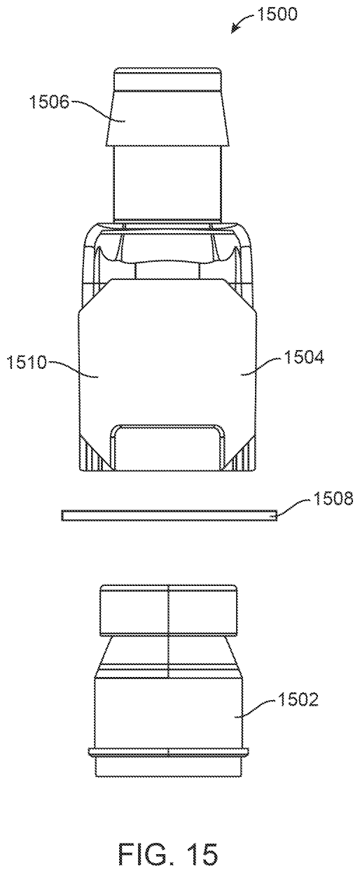

Referring now to FIGS. 15-17, an alternative quick-disconnect assembly 1500 for use with the air purification device 102 is shown, according to an exemplary embodiment. As best shown in FIG. 15, the quick-disconnect assembly 1500 includes a male body portion 1502, a female quick-disconnect portion 1504, a tube connection portion 1506, and a battery retention collar 1508. The male body portion 1502 is configured to extend through the outlet port 134 of the rear housing component 111 and provide an airflow passage between the outlet duct 162 and the female quick-disconnect portion 1504. The female quick-disconnect portion 1504 is configured to be selectively coupled to the male body portion 1502 by sliding the female quick-disconnect portion 1504 onto the male body portion 1502. The female quick-disconnect portion 1504 includes a quick-disconnect slide mechanism 1510 configured to selectively de-couple the female quick-disconnect portion 1504 from the male body portion 1502. The tube connection portion 1506 coupled to the female quick-disconnect portion 1504 and is configured to engage the breathing tube 104.

Accordingly, during use, a user may push the female quick-disconnect portion 1504 onto the male body portion 1502 to quickly couple the female quick-disconnect portion 1504 to the male body portion 1502, thereby creating a continuous airflow path from the outlet duct 162, through the male body portion 1502, through the female quick-disconnect portion 1504, through the tube connection portion 1506, and into the breathing tube 104 to be delivered to the user via the hood 106.

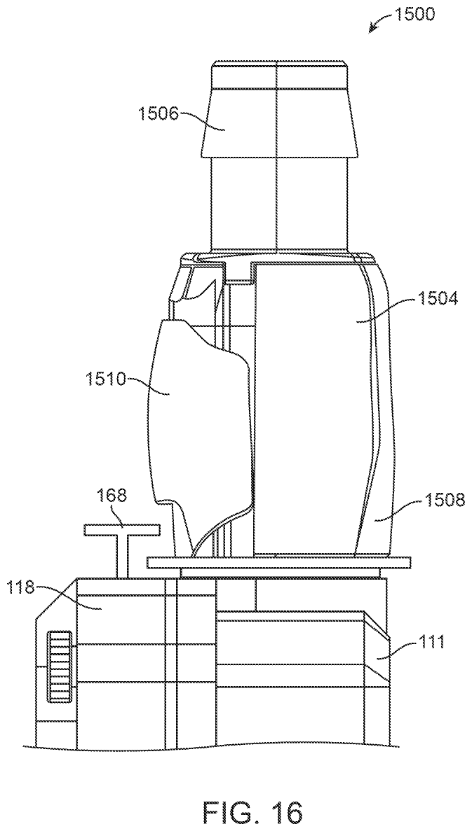

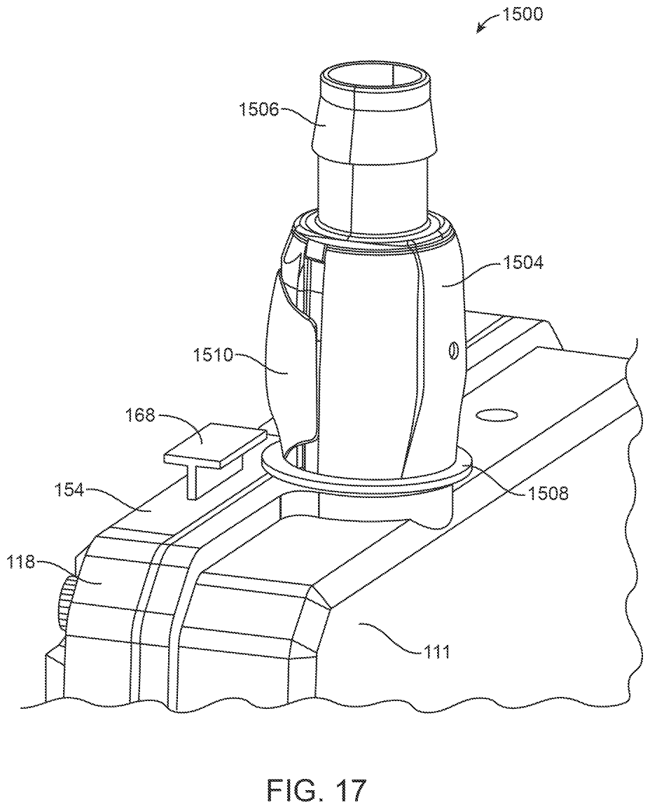

Referring now to FIGS. 16 and 17, during operation, the battery retention collar 1508 may be disposed around the male body portion 1502 between the female quick-disconnect portion 1504 and a top surface of the battery tray 154 (as best shown in FIG. 17) when the female quick-disconnect portion 1504 is slid onto the male body portion 1502. The battery retention collar 1508 is thus configured to prevent the battery tray 154 from being removed during operation, thereby preventing the air purification device 102 from being inadvertently powered off during use (e.g., in a contaminated area).

In some instances, the battery retention collar 1508 may be a separate component slid over the male body portion 1502 prior to connecting the female quick-disconnect portion 1504. In some other instances, the battery retention collar 1508 may be affixed to a lower end of the female quick-disconnect portion 1504, such that the battery retention collar 1508 is slid over the male body portion 1502 with the female quick-disconnection portion 1504. In either case, the battery retention collar 1508 may be made of a variety of materials, such as, for example, plastic, metal, or any other suitable material or combination of materials. Additionally, in some instances, the battery retention collar 1508 may vary in diameter and/or thickness.

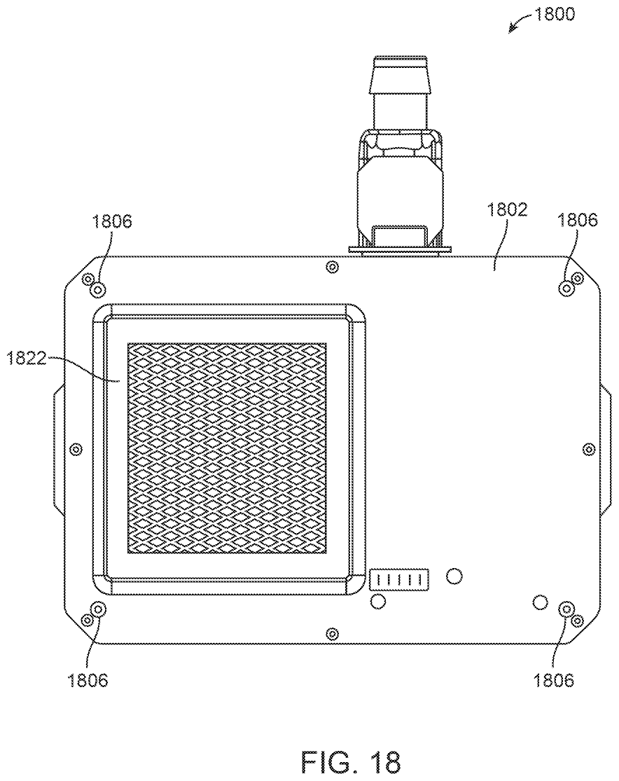

Referring now to FIGS. 18-20, another air purification device 1800 is shown, according to an exemplary embodiment. The air purification device 1800 is substantially similar to the air purification device 102 discussed above. Accordingly, the following description will focus on the differences between the air purification device 1800 and the air purification device 102.

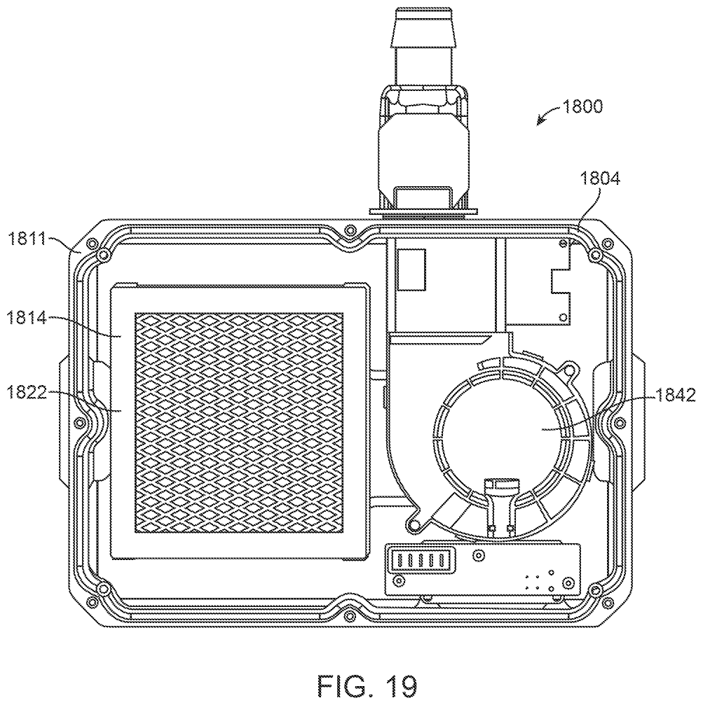

For example, the air purification device 1800 similarly includes a rear housing component 1811 (shown in FIG. 19). However, instead of a front housing component (e.g., similar to the front housing component 110 discussed above), the air purification device 1800 includes a front external seal 1802 configured to create a hermetically sealed interior space within the air purification device 1800. For example, the rear housing component 1811 includes a sealing gasket 1804 that extends around a periphery of the rear housing component 1811. When assembled, the front external seal 1802 has a rearwardly extending peripheral edge configured to rest against and create a hermetic seal with the sealing gasket 1804 of the rear housing component 1811. With the front external seal 1802 in place against the sealing gasket 1804 (shown in FIG. 19), the front external seal 1802 may be tightened against the sealing gasket 1804, and thereby fixed to the rear housing component 1811, via a plurality of threaded fasteners 1806.

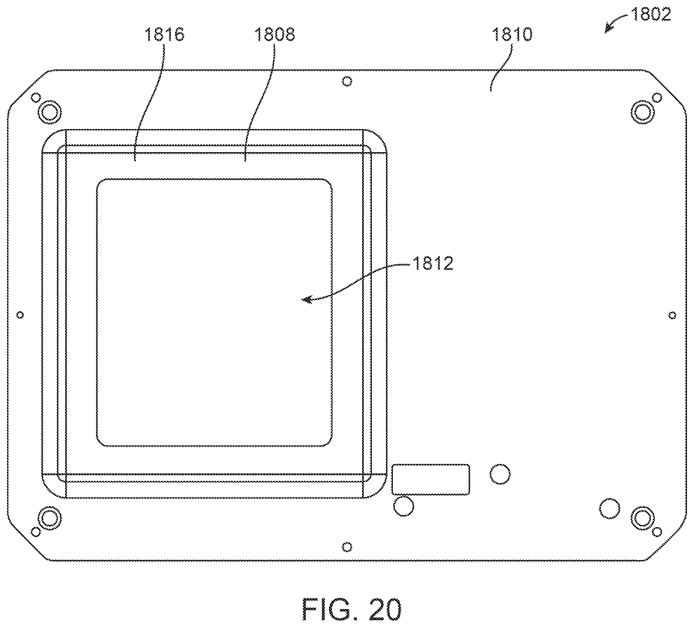

As best illustrated in FIG. 20, the front external seal 1802 further includes a filter seal contact portion 1808 that is recessed into a front surface 1810 of the front external seal 1802. The filter contact portion 1808 further includes a filter opening 1812 configured to permit air to be pulled into the air purification device 1800 through a filter 1822 (e.g., similar to the filter 122 discussed above).

In some instances, the filter 1822 may be disposed within the air purification device 1800 (as shown in FIG. 19). In these instances, when the front external seal 1802 is fastened onto the rear housing component 1811, an inner surface of the filter seal contact portion 1808 is configured to contact a front peripheral edge 1814 of the filter 1822, thereby creating a hermetic seal between the front external seal 1802 and the front peripheral edge 1814 of the filter 1822. In other instances, the filter 1822 may be disposed external to the air purification device 1800 (as shown in FIG. 18), within the filter contact portion 1808. In these instances, the filter 1822 may have an adhesive applied to a rear peripheral edge that is configured to contact an outer surface 1816 of the filter seal contact portion 1808 (shown in FIG. 20), thereby creating a similar hermetic seal between the front external seal 1802 and the rear peripheral edge of the filter 1822. By having the filter 1822 arranged externally with respect to the air purification device 1800, the filter 1822 may be quickly replaced by pulling the filter 1822 out of the filter seal contact portion 1808 and placing another in its place.

Accordingly, the front external seal 1802 allows for the air purification device 1800 to have a substantially hermetically-sealed internal cavity, where only air pulled through the filter 1822 is allowed to enter the internal cavity within the air purification device 1800 while the air purification device 1800 is operating. As such, the air purification device 1800 having the hermetically-sealed internal cavity may utilize a fan 1842 (shown in FIG. 19) that optionally does not have a sealed housing. Further, the air purification device 1800 may have all associated electronics (e.g., a battery similar to the battery 129, the fan 1842, etc.) configured to operate the air purification device 1800 housed within the hermetically sealed internal cavity. As such, the electronics of the air purification device 1800 may beneficially be protected from moisture (e.g., the air purification device 1800 may be substantially waterproof or water resistant).

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed (e.g., within plus or minus five percent of a given value for a distance, speed, rate, angle or other parameter) are considered to be within the scope of the invention as recited in the appended claims.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the embodiments described herein.

While this specification contains many specific implementation details, these should not be construed as limitations on the scope of any embodiment or of what may be claimed, but rather as descriptions of features specific to particular implementations of particular embodiments. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A respirator system, comprising:
a hood configured to be worn by a user;
a breathing tube coupled to the hood, the breathing tube having an inner surface provided with an antimicrobial coating; and
an air purification device configured to be worn by the user, the air purification device coupled to the breathing tube and further configured to deliver filtered air to the hood via the breathing tube, the air purification device comprising:
a housing comprising a front housing component and a rear housing component;
a back pad arranged adjacent to the rear housing component and configured to provide a cushion between the rear housing component and the user's body;
a filter arranged within the housing;
a fan arranged within the housing, the fan configured to pull ambient air through the filter and deliver the filtered air through the breathing tube to the hood;
a power source arranged within the housing, the power source configured to supply power to the fan; and
a controller arranged within the housing, the controller being communicatively coupled to the fan and the power source, the controller being configured to regulate a speed of the fan.

2. The respirator system of claim 1, wherein the antimicrobial coating comprises a silver ion coating.

3. The respirator system of claim 1, further comprising a flow rate sensor in communication with the controller, the flow rate sensor being configured to sense a flow rate of filtered air provided from the fan to the hood, and wherein the controller is configured to regulate the speed of the fan to cause the flow rate of the filtered air to be in a range of approximately 6 cubic feet per minute to approximately 9 cubic feet per minute.

4. The respirator system of claim 1, further comprising a heart rate monitor in communication with the controller, the heart rate monitor configured to detect a heart rate of the user, and wherein the controller is configured to regulate the speed of the fan based on the heart rate of the user.

5. The respirator system of claim 4, wherein the controller is configured to, upon detection of an increase in the heart rate of the user, increase the speed of the fan.

6. The respirator system of claim 1, wherein the breathing tube has quick-disconnect fittings configured to couple the breathing tube to the air purification device or the hood.

7. The respirator system of claim 1, wherein the breathing tube has at least one self-sealing end configured to automatically provide a hermetic seal when the breathing tube is disconnected from at least one of the air purification device or the hood.

8. The respirator system of claim 1, wherein the back pad is formed of at least one of a foam material or a gel material.

9. The respirator system of claim 1, further comprising an external device in communication with the controller, the external device configured to allow for remote controlling of the air purification device.

10. The respirator system of claim 1, wherein the controller is configured to communicate information relating to a heart rate of the user, a flow rate of filtered air, and the speed of the fan to an external device.

11. An air purification device configured to be worn by a user and to deliver filtered air to the user via a breathing tube, the air purification device comprising:
a housing comprising a front housing component and a rear housing component;
a back pad arranged adjacent to the rear housing component and configured to provide a cushion between the rear housing component and the user's body;
a filter arranged within the housing;
a fan arranged within the housing, the fan configured to pull ambient air through the filter and deliver the filtered air through the breathing tube to the user;
a power source arranged within the housing, the power source configured to supply power to the fan; and
a controller arranged within the housing, the controller being communicatively coupled to the fan and the power source, the controller being configured to regulate a speed of the fan.

12. The air purification device of claim 11, further comprising a flow rate sensor in communication with the controller, the flow rate sensor being configured to sense a flow rate of filtered air provided from the fan to the user, and wherein the controller is configured to regulate the speed of the fan to cause the flow rate of the filtered air to be in a range of approximately 6 cubic feet per minute to approximately 9 cubic feet per minute.

13. The air purification device of claim 12, wherein the controller is configured to receive a detected heart rate of the user via a heart rate monitor worn by the user, and wherein the controller is configured to regulate the speed of the fan based on the detected heart rate of the user.

14. The air purification device of claim 13, wherein, upon detection of an increase in the detected heart rate of the user, the controller is configured to increase the speed of the fan.

15. The air purification device of claim 11, further comprising a self-sealing outlet port configured to automatically seal when the breathing tube is disconnected from the air purification device.

16. The air purification device of claim 11, wherein the power source is a battery, and the battery is rechargeable and replaceable.

17. The air purification device of claim 11, wherein the back pad is formed of at least one of a foam material or a gel material.

18. A respirator system, comprising:
a hood configured to be worn by a user;
a breathing tube coupled to the hood;
a heart rate monitor configured to detect a heart rate of the user; and
an air purification device configured to be worn by the user, the air purification device coupled to the breathing tube and further configured to deliver filtered air to the hood via the breathing tube, the air purification device comprising:
a housing comprising a front housing component and a rear housing component;
a back pad arranged adjacent to the rear housing component and configured to provide an ergonomic cushion between the rear housing component and the user's body;
a filter arranged within the housing;
a fan arranged within the housing, the fan configured to pull ambient air through the filter and deliver the filtered air through the breathing tube to the hood;
a power source arranged within the housing, the power source configured to supply power to the fan; and
a controller arranged within the housing, the controller being communicatively coupled to the fan, the power source, and the heart rate monitor, the controller being configured to regulate a speed of the fan based on the heart rate of the user.

19. The respirator system of claim 18, wherein, upon detection of an increase in the heart rate of the user, the controller is configured to increase the speed of the fan.

20. The respirator system of claim 18, wherein the breathing has an inner surface provided with an antimicrobial coating.
